(19) United States
(12) Patent Application Publication
(10) Pub. No.: US 2025/0388715 A1
(43) Pub. Date: Dec. 25, 2025

(54) RESIN COMPOSITION AND CURED PRODUCT THEREOF

(71) Applicant: PANCOLOUR INK CO., LTD., Taoyuan City (TW)

(72) Inventors: WEN-CHANG SHEN, Taoyuan City (TW); YU-CHING PAI, Taoyuan City (TW); MEI-CHUAN HSU, Taoyuan City (TW)

(73) Assignee: PANCOLOUR INK CO., LTD., Taoyuan City (TW)

(21) Appl. No.: 18/793,967

(22) Filed: Aug. 5, 2024

(30) Foreign Application Priority Data
Jun. 20, 2024 (TW) 113122859

(51) Int. Cl. C08G 18/04; C08G 18/12

(52) U.S. Cl. CPC C08G 18/04; C08G 18/12

(57) ABSTRACT

Provides a resin composition, which includes: a first component comprising 75 to 85 parts by weight of polyurethane polyurea methacrylate prepolymer, 15 to 25 parts by weight of a diluting monomer and 0.5 to 1.5 parts by weight of a photoinitiator; and a second component comprising an aliphatic diamine, and an equivalent number ratio of active amine groups in the aliphatic diamine to isocyanate groups in the polyurethane polyurea methacrylate prepolymer is 0.9 to 1.0; wherein the polyurethane polyurea methacrylate prepolymer comprises prepolymer A made from polytetramethylene ether glycol and prepolymer B made from polypropylene glycol, a weight ratio of the prepolymer A to the prepolymer B is 1.0 to 3.0, the diluting monomer comprises an acrylate monomer and a vinyl ether monomer, and the acrylate monomer has a glass transition temperature of less than 25° C.

### CROSS-REFERENCE TO RELATED APPLICATION

This non-provisional application claims priority under 35 U.S.C. § 119 (a) on Patent Application No(s). 113122859 filed in Taiwan, R.O.C. on Jun. 20, 2024, the entire contents of which are hereby incorporated by reference.

### BACKGROUND OF THE INVENTION

### 1. Field of the Invention

The present disclosure relates to a resin composition and a cured product thereof, and in particular to a resin composition and a cured product thereof that are suitable for making a 3D printing elastomer.

### 2. Description of the Related Art

3D printing refers to a process of forming three-dimensional objects by layering and stacking raw materials. 3D printing does not require molds, and allows direct control of 3D printing equipment based on computer-generated 3D model files to manufacture objects. The printed 3D objects can possess arbitrary shapes and geometric features.

In recent years, some people have used photocurable resin as the raw material in 3D printing technology and introduce photocuring technology. Subsequently, 3D photocuring technologies have evolved, such as stereolithography (SLA), digital light processing (DLP), and lighting panel (LCD) technologies. These advancements have enabled the widespread manufacturing of 3D printed molded products using the aforementioned 3D photocuring technologies.

In addition, as to the photocurable resin, there has been a proposal for a composition comprising a polyurethane polyurea methacrylate prepolymer as the main body, which uses tert-butylaminoethyl methacrylate (t-BAEMA) as the blocking agent. After UV curing, heating is applied to unblock the blocking agent, which releases isocyanate to undergo a thermal condensation reaction with the chain extender pre-mixed in, forming a cured resin product with a crosslinked network structure of high molecular weight thermoplastic polyurethane (polyurea) resin and poly(methacrylate).

Compared with the cured product of the same type polyurethane methacrylic resin cured purely by UV light, the ultimate tensile strength and elongation at break of the above-mentioned cured resin product can be greatly improved.

### BRIEF SUMMARY OF THE INVENTION

However, while conventional photocurable resins are known for producing cured resin products with high elongation at break and high ultimate tensile strength, there is a lack of explanation in conventional techniques regarding photocurable resins capable of producing cured resin products with important application properties such as rebound, resilience, damping, and hysteresis, which restricts the applications of 3D printing and presents an opportunity for further improvement.

Furthermore, among the characteristic parameters of the resin composition and its cured product that can be used as elastomers, in addition to stress/strain relationships such as ultimate tensile strength and elongation at break, and static properties such as softening point and hardness, there are differences in dynamic damping characteristics, such as resilience/cushioning, etc. These are characteristic indicators that represent the energy that an elastomer can store when strained due to stress extension, and the stored energy that can be released when the stress is removed.

On the other hand, the viscoelastic properties (or loss factor) of an elastomer determines the ratio of plastic deformation to elastic deformation under the action of stress. The higher the elastic deformation ratio is, the better the resilience is; and the higher the plastic deformation ratio is, the better the hysteresis is. However, the conventional tensile test standard is a static property measurement method. The elongation at break is measured based on the stress/strain relationship in a single direction, at a constant speed and under slow stretching and represents the total value of plastic deformation and elastic deformation such that the two deformation attributes cannot be distinguished.

In addition, because the stresses suffered by dynamic characteristics are mostly rapid, periodic/repeated, or directional changing properties, and their strain ranges are far smaller than the strain amount of the elongation at break (usually more than 100%) (for example, the strain amount (elongation) of vibration absorption applications is usually less than 25%). Therefore, the dynamic characteristics requirements of the elastomer, such as resilience/hysteresis, cannot be achieved by only adjusting the single cycle failure test characteristics, such as the ultimate tensile strength and elongation at break, and it is difficult to predict resilience and hysteresis directly from ultimate tensile strength and elongation at break.

Based on the above, although the conventional technology has improved the strength and extensibility of 3D printing UV light-cured elastomers, there is still a demand for resin compositions for 3D printing with material properties such as high resilience in many practical applications of elastomers that require resilience (for example, shoe soles, sports equipment, rubber-coated wheels, shock-absorbing parts, suction cups and cushioning pads, etc.).

Next, the inventors found that by using the specific first component and second component, the resin composition of the present disclosure can obtain a cured product with not only high resilience but also high ultimate tensile strength and elongation at break after UV light curing molding and thermal condensation in solid phase.

In order to solve the above problems, a resin composition according to one aspect of the present disclosure comprises: a first component comprising 75 to 85 parts by weight of polyurethane polyurea methacrylate prepolymer, 15 to 25 parts by weight of a diluting monomer and 0.5 to 1.5 parts by weight of a photoinitiator; and a second component comprising an aliphatic diamine, and an equivalent number ratio of active amine groups in the aliphatic diamine to isocyanate groups in the polyurethane polyurea methacrylate prepolymer (equivalent number of the active amine groups/equivalent number of the isocyanate groups) is 0.9 to 1.0; wherein the polyurethane polyurea methacrylate prepolymer comprises prepolymer A made from polytetramethylene ether glycol and prepolymer B made from polypropylene glycol, and a weight ratio of the prepolymer A to the prepolymer B (prepolymer A/prepolymer B) is 1.0 to 3.0, and the diluting monomer comprises an acrylate monomer and a vinyl ether monomer, and the acrylate monomer has a glass transition temperature of less than 25° C.

In one embodiment, a content of the vinyl ether monomer: a content of the acrylate monomer is 1:2˜5.

In one embodiment, the glass transition temperature of the acrylate monomer is less than 0° C.

In one embodiment, the polyurethane polyurea methacrylate prepolymer is formed in the following manner: reacting polytetramethylene ether glycol or polypropylene glycol with diisocyanate to form polyurethane, and then capping an isocyanate functional group at an end of the polyurethane using tert-butylaminomethacrylate. Further, in a preferred embodiment, the tert-butylaminomethacrylate is tert-butylaminoethyl methacrylate, and the diisocyanate is isophorone diisocyanate or trimethylhexamethylene diisocyanate.

In one embodiment, the photoinitiator is at least one selected from the group consisting of (2,4,6-trimethylbenzoyl)diphenylphosphine oxide, (2,4,6-trimethylbenzoyl)di-p-tolylphosphine oxide and bis(2,4,6-trimethylbenzoyl)-phenylphosphine oxide.

In one embodiment, a viscosity of the resin composition at 25° C. is 7,000˜10,000 cP.

In order to solve the above problems, a cured product of a resin composition according to one aspect of the present disclosure is formed by first subjecting the resin composition described above to UV light curing molding, followed by heating and polycondensation in the solid phase, and the cured product of the resin composition has a resilience of more than 30%, an ultimate tensile strength of more than 15 MPa, and an elongation at break of more than 200%.

One aspect of the present disclosure has been accomplished in view of the conventional problems described above, and an object thereof is to provide a resin composition and a cured product thereof. Furthermore, a cured product of the resin composition having not only high resilience but also high ultimate tensile strength and elongation at break can be provided using the aforementioned resin composition.

### DETAILED DESCRIPTION OF THE INVENTION

Below are specific embodiments of the present disclosure, illustrating its implementation through detailed examples. Those skilled in the art can understand additional advantages and benefits of the present disclosure from the disclosures in this specification. The present disclosure can also be implemented or applied through various other specific embodiments. Details in this specification can be modified or changed based on different perspectives and applications, as long as such modifications and changes do not depart from the spirit of the disclosure.

Unless otherwise stated in the context, the term “or” used in the specification and the appended claims includes the meaning of “and/or.”

Unless otherwise stated in the text, the term “A˜B” used in the specification and the appended claims includes the meaning of “between A and B”. For example, the term “10˜40% by weight” includes the meaning of “between 10% by weight and 40% by weight.”

First, the resin composition of the present disclosure includes a first component and a second component. Hereinafter, each composition of the first component and the second component will be described in detail.

### <First Component>

The first component includes a polyurethane polyurea methacrylate prepolymer (hereinafter also referred to as a prepolymer), a diluting monomer and a photoinitiator. Each ingredient will be described in detail below.

### <<Polyurethane Polyurea Methacrylate Prepolymer>>

First of all, polyurethane polyurea methacrylate prepolymer is made by blocking the isocyanate functional group at the end of polyurethane with a reactive blocking agent, so it can also be called reactive blocked polyurethane polyurea methacrylate prepolymer. The reactive blocking agent uses tert-butylaminomethacrylate as the isocyanate functional group. One end of the reactive blocking agent is an unsaturated double bond of methacrylic acid and the other end is a tert-butylamino group. The steric hindrance of this tert-butylamino group causes the reaction bond with the isocyanate functional group to become thermally unstable, such that the chain can be broken under heating to re-release the isocyanate functional group, which then undergo polycondensation reaction with the pre-mixed chain extender (such as the second component described below). In addition, the prepolymer can undergo free radical copolymerization with the diluting monomer described below under UV light exposure, to cure and form a resinous embryo.

In an embodiment, the prepolymer can be formed in the following manner. First, polyurethane is formed by reacting a 1:2 molar ratio of polyether polyol with diisocyanate, followed by using a reactive blocking agent to cap the isocyanate functional groups at the ends of the polyurethane. The reactive blocking agent may be t-butylaminomethacrylate, for example, it can be t-butylaminopropyl methacrylate (t-BAPMA) or t-butylaminoethyl methacrylate (t-BAEMA), and is preferably t-BAEMA.

In particular, the aforementioned diisocyanate is an aliphatic diisocyanate, which may be at least one selected from the group consisting of isophorone diisocyanate (IPDI), hexamethylene diisocyanate (HDI), dicyclohexylmethane diisocyanate (HMDI) and trimethyl hexamethylene diisocyanate (TMDI), and is preferably IPDI or TMDI.

In addition, the molecular weight of the aforementioned polyether polyol is preferably greater than 1,000, more preferably 2,000 or more. The aforementioned polyether polyol may be polytetramethylene ether glycol (PTMEG), polypropylene glycol (PPG) or polyethylene glycol (PEG), and is preferably PTMEG or PPG.

Next, the inventors discover that among these, PTMEG is a fully linear structured molecule. The hard segments of the polyurethane molecules derived from PTMEG can effectively stack closely due to strong hydrogen bonding between the chains, leading to higher viscosity. However, its soft segments have high flexibility, resulting in high elongation at break and excellent resilience. On the other hand, PPG contains methyl side chains on its molecular chains, which can disrupt hydrogen bonding between molecules, such that the ultimate tensile strength and elongation at break are lower, but the viscosity is lower. The present inventors found that by using PTMEG and PPG as polyether polyols and preparing polyurethane respectively, a prepolymer suitable for the resin composition of the present disclosure can be obtained. Hereinafter, the prepolymer derived from PTMEG is called prepolymer A, and the prepolymer derived from PPG is called prepolymer B; wherein, the weight ratio of PTMEG/PPG is 1.0˜3.0, preferably 1.2˜ 2.2.

In addition, the content of the prepolymer is 75-85 parts by weight in the first component, preferably 80-85 parts by weight. If the prepolymer content is too low (e.g., less than 75 parts by weight in the first component), it can affect the resilience, elongation at break, and tensile strength of the cured product. If the prepolymer content is too high (e.g., exceeding 85 parts by weight in the first component), the viscosity of the resin composition may exceed the upper limit of printable viscosity of 3D printing equipment, resulting in failure to print or molding defects.

Furthermore, as the viscosity of the resin composition increases, during 3D printing, the rate at which the resin composition flows back to refill the printing surface after each layer is completed and lifted becomes slower. This slower flow rate leads to excessively long printing time of the whole stacking layer, which does not meet the production demands in industry. However, generally speaking, the viscosity of the prepolymer (referring to the preparation examples described below, for example, more than 15,000 cP) is much higher than the optimal printing viscosity range (for example, 7,000˜10,000 cP), so it is necessary to use the diluting monomer described below to reduce its viscosity.

### <<Diluting Monomer>>

In addition to the function of reducing the viscosity, the diluting monomer can also be copolymerized and cured with the prepolymer under UV light to form the resinous embryo. In addition, the diluting monomer includes acrylate monomers and vinyl ether monomers, and the content of the diluting monomer is 10 to 25 parts by weight, preferably 15 to 20 parts by weight, of the first component. By using the diluting monomer with specific amounts and specific compositions, the viscosity of the resin composition containing the prepolymer can be reduced below the upper limit of the printable viscosity of the 3D printing equipment.

Next, according to the common knowledge of the present disclosure, the second stage of thermal curing is a key step to improve the molecular weight and various mechanical properties. However, the inventor found that to achieve enhanced characteristics such as improved resilience in thermal curing, the reaction must occur under solid-phase conditions, in which the shape of the resinous embryo is fixed. However, if the reaction is carried out in the solid phase, the mobility of the reactants is limited. Therefore, how to pre-control the copolymer molecular structure and composition distribution of the resin composition after UV light curing in the first stage of light curing so that the resinous embryo has sufficient strength and the terminal diisocyanate functional group of the polyurethane molecule released after unblocking can be effectively contacted with the chain extender to facilitate the polycondensation reaction and effectively increase the molecular weight of the final product, is the key technology to improve resilience, elongation at break and ultimate tensile strength.

In addition, when selecting the diluting monomer, if there is no deliberate control, the free radical copolymerization reaction with the prepolymer will form a polymethacrylate-acrylate random copolymer, that is, the diluting monomer will be randomly distributed between the molecular chains of the prepolymer, thereby expanding the spacing between the prepolymer molecules to varying degrees. This spacing not only hinders the chain growth reaction between the diisocyanate functional group at the end of the unblocked polyurethane molecule and the chain extender, but also hinders the hydrogen bond adsorption of hard segments between the thermoplastic polyurethane polyurea polymer chains (i.e., the formation of physical cross-links) after thermal polycondensation, and will retard the extension and recovery of polyurethane polymers, thereby affecting resilience, ultimate tensile strength and elongation at break.

Furthermore, according to common knowledge in the technical field of the present disclosure, UV light curing is a free radical polymerization reaction, and the reaction rate constant of the unsaturated double bonds of various diluting monomers will be affected by the surrounding substituents. Generally speaking, the reaction rate from fast to slow is: acrylate>methacrylate>vinyl ether. Based on this, the inventors found that if an acrylate with a higher reaction rate is selected as the diluting monomer and a prepolymer with a lower reaction rate is used in conjunction with methacrylate as the reactive functional group, when copolymerization is performed under UV irradiation, through the difference in reaction rates, faster-reacting diluent monomers undergo free radical chain growth reactions first to form localized polyacrylate homopolymers, thereby inducing phase separation from prepolymer with methacrylate functional groups. In this way, the prepolymer molecules can be aggregated to the greatest extent, and the chain extender and isocyanate functional groups in the second-stage solid-state thermal curing (thermal polycondensation) reaction can be effectively carried out, which is not only beneficial to the increase in molecular weight resulted from the thermal polycondensation reaction, but also conducive to the formation of hydrogen bonds between polyurethane polyurea polymer molecules and phase separation.

Next, the inventors also found that if the vinyl ether monomer with slower reactivity is used as the diluting monomer, the vinyl ether monomer will not participate in the copolymerization during the main reaction between the acrylate monomer and the prepolymer. Until the final copolymerization with (meth)acrylate, it continues to play its role as a solvent in reducing the viscosity of the composition and swelling the polymer, reducing the restriction on the mobility of reactants due to the increase in molecular weight, improving the double bond conversion rate of the UV curing reaction in the first stage, and further facilitating the polymerization-induced phase separation simultaneously. Based on this, the diluting monomer of the present disclosure includes the acrylate monomer and the vinyl ether monomer.

Moreover, as for the acrylate monomer, the number of its unsaturated double bond functional groups is 2 or more. It is preferable to use di-functional monomers or tri-functional monomers, and even better to use di-functional monomers or a mixture of di-functional monomers and multi-functional monomers with the di-functional monomers as the main ingredient. The glass transition temperature (Tg) of the acrylate monomer is less than 25° C., preferably less than 0° C. This is because the lower the Tg is, the easier the thermal condensation reaction occurs, leading to better resilience in the resin composition and its cured products.

In the present disclosure, the acrylate monomer is not particularly limited as long as it meets the above characteristics. In some specific examples, the acrylate monomer may be polyethylene glycol 300 diacrylate (PEG300DA), polyethylene glycol 400 diacrylate (PEG400DA), polyethylene glycol 600 diacrylate (PEG600DA), (2) ethoxylated 1,6-hexanediol diacrylate (HD2EODA), (10) ethoxylated bisphenol A diacrylate (BPA10EODA), (20) ethoxylated bisphenol A diacrylate (BPA20EODA), (30) ethoxylated bisphenol A diacrylate (BPA30EODA), polypropylene glycol 400 diacrylate (PPG400DA), polypropylene glycol 750 diacrylate (PPG750DA), (6) ethoxylated trimethylolpropane triacrylate (TMP6EOTA), (9) ethoxylated trimethylolpropane triacrylate (TMP9EOTA), (15) ethoxylated trimethylolpropane triacrylate (TMP15EOTA), tetramethylene ether glycol diacrylate (TTEGDA) or polytetramethylene ether glycol 650 diacrylate (PTMG650DA), etc.

In addition, as for the vinyl ether monomer, it can be monovinyl ether or divinyl ether, preferably divinyl ether. In some specific examples, the divinyl ether monomer may be diethylene glycol divinyl ether (DEGDVE), triethylene glycol divinyl ether (TEGDVE) or 1,4-cyclohexanedimethanol divinyl ether (CHDM-di) etc.

However, in the UV light-cured free radical polymerization reaction, because the homopolymerization reaction rate of vinyl ether is extremely low, it can only be copolymerized with methacrylate and acrylate. Therefore, if the amount of vinyl ether is too much (for example, more than 0.5 times of the acrylate monomer), excess vinyl ether will exist in the resinous embryo in the form of unreacted free monomer, which will affect the strength of the resinous embryo. On the contrary, if the amount of vinyl ether is too less (for example, less than 0.2 times of the acrylate monomer), its solvent effect of reducing the viscosity of the composition and swelling the polymer cannot be fully exerted. Therefore, regarding the amount of vinyl ether, the preferable ratio of vinyl ether monomer to acrylate monomer is 1:2˜5, with a more preferable ratio of 1:2.5˜4.

### <<Photoinitiator>>

The resin composition of the present disclosure uses a photoinitiator to initiate the aforementioned UV photocuring reaction. The photoinitiator may be a conventional photoinitiator, such as (2,4,6-trimethylbenzoyl)diphenylphosphine oxide (TPO), (2,4,6-trimethylbenzoyl)di-p-tolylphosphine oxide (TMO) or bis(2,4,6-trimethylbenzoyl)phenylphosphine oxide (Irgacure-819, manufactured by BASF), and is not particularly limited. In addition, the content of the photoinitiator is preferably 0.5˜1.5 parts by weight in the first component.

### <<Other Ingredients>>

In addition, other ingredients such as conventional colorants, heat stabilizers, UV absorbers, matting powders, etc. may be added to the first component without affecting the function of the resin composition of the present disclosure.

### <Second Component>

In the resin composition of the present disclosure, the second component includes an aliphatic diamine as a chain extender, preferably in liquid form. In specific examples, the aliphatic diamine may be 4.4′-diaminodicyclohexylmethane (PACM) or 3,3′-dimethyl-4.4′-diaminodicyclohexylmethane (DMDC), with DMDC being particularly preferred. As to the content of the second component, the equivalent number ratio of the active amine groups in the aliphatic diamine to the isocyanate groups in the prepolymer (equivalent number of active amine groups/equivalent number of isocyanate groups) is 0.9˜1.0, preferably 0.90˜0.95. The equivalent number ratio within the above range is beneficial to increasing the molecular weight of the resin composition during the thermal polycondensation reaction.

In addition, as mentioned above, the cured product of the resin composition of the present disclosure is completed through two-stage polymerization: UV light curing molding is first performed in the liquid phase, followed by thermal polycondensation in the solid phase. The UV curing in the first stage will first produce a resinous embryo of polymethacrylate-acrylate copolymer. The strength of this resinous embryo is determined by the softening temperature, number of double bond functional groups, reaction conversion rate and composition ratio of individual materials in the combination of prepolymer and diluting monomers. The higher the softening temperature, the number of double bond functional groups and the reaction conversion rate of the diluting monomer, the higher the strength and rigidity of the resinous embryo, which can resist the influence of separation force (Stefan Adhesion) when the laminated part is to be separated from the release film during 3D printing, thereby avoiding delamination and displacement that may cause deformation defects in printed objects, as well as problems such as softening and deformation caused by the low softening temperature of the acrylate copolymer during the second stage of thermal curing. In addition, in order to be suitable for 3D printing, the viscosity of the resin composition at 25° C. is preferably 7,000˜10,000 cP.

In addition, the present disclosure uses Phrozen's 3D printing UV light curing equipment (Phrozen Sonic Mighty 4K) to print samples of the resin composition. The printing parameters are shown in Table 1 below.

TABLE 1

| Equipment | Phrozen Sonic Mighty 4K | |
|---|---|---|
| Single-layer | 50~100 | μm |
| printing | | |
| thickness | | |
| Time for general | 10~15 | seconds |
| layer | | |

| | |
|---|---|
| Time for bottom | 1~2 layers, 5~10 seconds in total |
| layer | |
| Light-off delay | 4~6 seconds in still time mode |

Next, after the printing is completed, the UV light-cured sample obtained from the first-stage is fully cleaned with alcohol to remove the excess resin composition remaining on the surface, and then placed in a hot air circulation oven for continuous heating at 115° C. for 6 hours to carry out the thermal polycondensation (thermal curing) reaction of the second stage. After the thermal curing is completed, the cured product of the resin composition is taken out and left to stand at room temperature for 24 hours, followed by physical property measurements. Among them, the ultimate tensile strength and elongation at break are measured in accordance with the elastomer tensile test standard of ASTM D412, using the dog bone type specimen of mold C. Furthermore, the resilience test is conducted in accordance with the vertical rebound test standard (Bayshore Resilience) of ASTM D2632, with a sample thickness of 12.5 mm, a drop hammer weight of 28 g, and a drop height of 400 mm. In addition, unless otherwise stated in the text, the viscosity values, tensile strength, elongation at break, resilience, etc. set forth in the specification and claims are all values measured at 25° C.

### EXAMPLES

Hereinafter, although the present disclosure is demonstrated specifically using various Examples and Comparative Examples, it is not limited thereto.

### Preparation Example 1

800 g of anhydrous PTMEG (molecular weight 2000) were added into a heated and stirred reaction vessel under a nitrogen atmosphere. Then, 177.83 g of IPDI were added and stirred until a uniform solution was obtained. Subsequently, 0.08 g of dibutyltin dilaurate (DBTDL) catalyst was added. The reaction was carried out at 70° C. for 3 hours, after which the heating was stopped. When the temperature dropped to 50° C., 150 g of t-BAEMA were slowly added while maintaining temperature and stirring continuously. After that, 300 ppm of hydroquinone monomethyl ether as a thermal stabilizer was added, and the reaction was carried out for 12 hours to obtain a clear viscous liquid with a viscosity of 156,000 cP, which was prepolymer A1 made from PTMEG.

### Preparation Example 2

The process followed the same steps as Preparation Example 1 except that the anhydrous PTMEG with a molecular weight of 2000 was substituted with anhydrous polypropylene glycol (PPG) with a molecular weight of 2000, obtaining a clear viscous liquid with a viscosity of 25,500 cP, which was prepolymer B1 made from PPG.

### Preparation Example 3

The process followed the same steps as Preparation Example 1 except that 177.83 g of IPDI were substituted with 166.79 g of trimethylhexamethylene diisocyanate (TMDI), obtaining a clear viscous liquid with a viscosity of 92,700 cP, which was prepolymer A2 made from PTMEG.

### Preparation Example 4

The process followed the same steps as Preparation Example 2 except that 177.83 g of IPDI were substituted with 166.79 g of trimethylhexamethylene diisocyanate (TMDI), obtaining a clear viscous liquid with a viscosity of 15,300 cP, which was prepolymer B2 made from PPG.

### Example 1

Referring to the compositions listed in Table 2 below, 50 parts by weight of prepolymer A1 (Preparation Example 1), 30 parts by weight of prepolymer B1 (Preparation Example 2), 15 parts by weight of (2) ethoxylated 1,6-hexanediol diacrylate (HD2EODA) (Miramer M202, Tg=−8° C., manufactured by Miwon Corp.) as the diluting monomer, and 5 parts by weight of triethylene glycol divinyl ether (TEGDVE) (DVE-3, manufactured by BASF Corp.) were added into the vessel in sequence. Next, all the ingredients were stirred continuously at room temperature with a mixer at 300 rpm for 30 minutes until they were evenly mixed, and then 1 part by weight of the photoinitiator (TPO) was added. Afterward, stirring for 15 minutes until complete dissolution, then filtering to remove impurities, and letting it stand until fully defoamed, which completed the preparation of the first component of Example 1.

Next, 6.1 parts by weight of the second component 3,3′-dimethyl-4,4-diaminodicyclohexylmethane (DMDC) (Baxxodur EC331, manufactured by BASF Corp.) were added into the above-mentioned vessel containing the first component in such a manner that the ratio of equivalents of active amine groups of the second component/equivalents of isocyanate groups of the prepolymer becomes 0.9. Next, after stirring at a rotation speed of 30 rpm for 10 minutes, the resin composition of Example 1 with a viscosity of 8,080 cP was obtained. After that, the resin composition of Example 1 was poured into the tray of the 3D printing equipment to print the dog bone samples of ASTM D412 mold C and the resilience test samples of ASTM D2632 by using the setting parameters of the 3D printing equipment in Table 1.

Afterwards, the printed sample was fully cleaned with alcohol to remove the residual resin mixture on its surface, and then moved into a hot air oven preheated to 115° C. for continuous heating treatment for 6 hours. After the heated resin mixture was taken out and allowed to stand for 24 hours, a cured product of the resin mixture of Example 1 was obtained. Finally, according to the above measurement methods, the ultimate tensile strength of the cured product of the resin mixture of Example 1 was measured to be 27.2 MPa, the elongation at break was 234%, and the resilience was 31%. In addition, the measured data are summarized in Table 2.

### Example 2

Except that the composition of the resin composition of Example 2 was changed according to Table 2 below, a cured product of the resin mixture of Example 2 was obtained in the same manner as Example 1, and the above physical properties were measured. The measured data are summarized in Table 2. It can be seen from Table 2 that the viscosity of the resin mixture of Example 2 is 7,500 cP, the ultimate tensile strength of the cured product of the resin mixture of Example 2 is 16.2 MPa, the elongation at break is 272%, and the resilience is 45%. Moreover, the Tg of polyethylene glycol 600 diacrylate (PEG600DA) (Miramer M286, manufactured by Miwon Corp.,) used in Example 2 is −41° C.

### Example 3

Except that the composition of the resin composition of Example 3 was changed according to Table 2 below, a cured product of the resin mixture of Example 3 was obtained in the same manner as Example 1, and the above physical properties were measured. The measured data are summarized in Table 2. It can be seen from Table 2 that the viscosity of the resin mixture of Example 3 is 9,520 cP, the ultimate tensile strength of the cured product of the resin mixture of Example 3 is 19.0 MPa, the elongation at break is 223%, and the resilience is 35%.

### Example 4

Except that the composition of the resin composition of Example 4 was changed according to Table 2 below, a cured product of the resin mixture of Example 4 was obtained in the same manner as Example 1, and the above physical properties were measured. The measured data are summarized in Table 2. It can be seen from Table 2 that the viscosity of the resin mixture of Example 4 is 9,050 cP, the ultimate tensile strength of the cured product of the resin mixture of Example 4 is 17.0 MPa, the elongation at break is 294%, and the resilience is 50%. Moreover, the Tg of polypropylene glycol 750 diacrylate (PPG750DA) (Miramer M2070, manufactured by Miwon Corp.,) used in Example 4 is −48° C.

### Example 5

Except that the composition of the resin composition of Example 5 was changed according to Table 2 below, a cured product of the resin mixture of Example 5 was obtained in the same manner as Example 1, and the above physical properties were measured. The measured data are summarized in Table 2. It can be seen from Table 2 that the viscosity of the resin mixture of Example 5 is 10,060 cP, the ultimate tensile strength of the cured product of the resin mixture of Example 5 is 21.1 MPa, the elongation at break is 263%, and the resilience is 40%. Moreover, the Tg of PEG600DA used in Example 5 is −41° C., and the Tg of (15) ethoxylated trimethylolpropane triacrylate (TMP15EOTA) (Miramer M3150, manufactured by Miwon Corp.,) used is −31° C.

### Example 6

Except that the composition of the resin composition of Example 6 was changed according to Table 2 below, a cured product of the resin mixture of Example 6 was obtained in the same manner as Example 1, and the above physical properties were measured. The measured data are summarized in Table 2. It can be seen from Table 2 that the viscosity of the resin mixture of Example 6 is 8,500 cP, the ultimate tensile strength of the cured product of the resin mixture of Example 6 is 19.3 MPa, the elongation at break is 254%, and the resilience is 41%.

### Example 7

Except that the composition of the resin composition of Example 7 was changed according to Table 2 below, a cured product of the resin mixture of Example 7 was obtained in the same manner as Example 1, and the above physical properties were measured. The measured data are summarized in Table 2. It can be seen from Table 2 that the viscosity of the resin mixture of Example 7 is 9,940 cP, the ultimate tensile strength of the cured product of the resin mixture of Example 7 is 17.5 MPa, the elongation at break is 280%, and the resilience is 48%.

### Example 8

Except that the composition of the resin composition of Example 8 was changed according to Table 2 below, a cured product of the resin mixture of Example 8 was obtained in the same manner as Example 1, and the above physical properties were measured. The measured data are summarized in Table 2. It can be seen from Table 2 that the viscosity of the resin mixture of Example 8 is 7,990 cP, the ultimate tensile strength of the cured product of the resin mixture of Example 8 is 27.0 MPa, the elongation at break is 225%, and the resilience is 32%.

### Comparative Example 1

Except that the composition of the resin composition of Comparative Example 1 was changed according to Table 2 below, a cured product of the resin mixture of Comparative Example 1 was obtained in the same manner as Example 1, and the above physical properties were measured. The measured data are summarized in Table 2. It can be seen from Table 2 that the viscosity of the resin mixture of Comparative Example 1 is 2,570 cP, the ultimate tensile strength of the cured product of the resin mixture of Comparative Example 1 is 8.9 MPa, the elongation at break is 130%, and the resilience is 22%.

### Comparative Example 2

Except that the composition of the resin composition of Comparative Example 2 was changed according to Table 2 below, a cured product of the resin mixture of Comparative Example 2 was obtained in the same manner as Example 1, and the above physical properties were measured. The measured data are summarized in Table 2. It can be seen from Table 2 that the viscosity of the resin mixture of Comparative Example 2 is 7,820 cP, the ultimate tensile strength of the cured product of the resin mixture of Comparative Example 2 is 27.0 MPa, the elongation at break is 190%, and the resilience is 29%. Moreover, the Tg of 1,6-hexanediol diacrylate monomer (HDDA) (Miramer M200, manufactured by Miwon Corp.,) used in Comparative Example 2 is 43° C.

### Comparative Example 3

Except that the composition of the resin composition of Comparative Example 3 was changed according to Table 2 below, a cured product of the resin mixture of Comparative Example 3 was obtained in the same manner as Example 1, and the above physical properties were measured. The measured data are summarized in Table 2. It can be seen from Table 2 that the viscosity of the resin mixture of Comparative Example 3 is 3,928 cP, the ultimate tensile strength of the cured product of the resin mixture of Comparative Example 3 is 7.6 MPa, the elongation at break is 375%, and the resilience is 15%. Moreover, the Tg of lauryl methacrylate (LMA) (Miramer M123, manufactured by Miwon Corp.,) used in Comparative Example 3 is −60° C., and the Tg of triethylene glycol dimethacrylate (TEGDMA) (Miramer M233, manufactured by Miwon Corp.,) is 53° C.

TABLE 2

| | Composition | | | | | | | | | Comp. | Comp. | Comp. |
|---|---|---|---|---|---|---|---|---|---|---|---|---|
| | (parts by weight) | Ex. 1 | Ex. 2 | Ex. 3 | Ex. 4 | Ex. 5 | Ex. 6 | Ex. 7 | Ex. 8 | Ex. 1 | Ex. 2 | Ex. 3 |
| First | Prepolymer A1 | 50.00 | — | — | 50.00 | 50.00 | 50.00 | 50.00 | 50.00 | — | 50.00 | 20.00 |
| component | Prepolymer B1 | 30.00 | 25.00 | — | 30.00 | 30.00 | 30.00 | 30.00 | 30.00 | 30.00 | 30.00 | 60.00 |
| | Prepolymer A2 | — | 50.00 | 50.00 | — | — | — | — | — | — | — | — |
| | Prepolymer B2 | — | — | 35.00 | — | — | — | — | — | — | — | — |
| | HDDA | — | — | — | — | — | — | — | — | — | 15.00 | — |
| | HD2EODA | 15.00 | — | 11.50 | — | — | 5.00 | — | 15.00 | 15.00 | — | — |
| | PEG600DA | — | 19.00 | — | — | 10.00 | 5.00 | 14.00 | — | — | — | — |
| | PEG750DA | — | — | — | 15.00 | — | 5.00 | — | — | — | — | — |
| | TMP15EOTA | — | — | — | — | 5.00 | — | — | — | — | — | — |
| | LMA | — | — | — | — | — | — | — | — | — | — | 15.00 |
| | TEGDMA | — | — | — | — | — | — | — | — | — | — | 5.00 |
| | Vinyl ether | 5.00 | 6.00 | 3.50 | 5.00 | 5.00 | 5.00 | 6.00 | 5.00 | 5.00 | 5.00 | — |
| | (TEGDVE) | | | | | | | | | | | |
| | photoinitiator | 1.00 | 1.00 | 1.00 | 1.00 | 1.00 | 1.00 | 1,00 | 1.00 | 1.00 | 1.00 | 1.00 |
| | Prepolymer | 1.67 | 2.00 | 1.43 | 1.67 | 1.67 | 1.67 | 1.67 | 1.67 | — | 1.67 | 0.33 |
| | A/Prepolymer B | | | | | | | | | | | |
| | Vinyl ether:acrylate | 1:3 | 1:3.2 | 1:3.3 | 1:3 | 1:3 | 1:3 | 1:23 | 1:3 | 1:3 | 1:3 | — |
| Second | DMDC | 6.10 | 5.72 | 6.48 | 6.10 | 6.10 | 6.10 | 6.10 | 6.77 | 6.10 | 6.10 | 5.42 |
| component | equivalent | 0.90 | 0.90 | 0.90 | 0.90 | 0.90 | 0.90 | 0.90 | 1.00 | 0.90 | 0.90 | 0.80 |
| | number ratio | | | | | | | | | | | |

Composition properties

| viscosity of resin composition (cP) | | 8080 | 7500 | 9520 | 9050 | 10060 | 8300 | 9940 | 7990 | 2570 | 7820 | 3928 |
|---|---|---|---|---|---|---|---|---|---|---|---|---|
| Cured product | Ultimate tensile | 27.2 | 16.2 | 19.0 | 17.0 | 21.1 | 19.3 | 17.5 | 27.0 | 8.9 | 27.0 | 7.6 |
| | strength (Mpa) | | | | | | | | | | | |
| | Elongation | 234 | 272 | 223 | 294 | 263 | 254 | 280 | 225 | 130 | 190 | 375 |
| | at break (%) | | | | | | | | | | | |
| | Resilience (%) | 31 | 45 | 35 | 50 | 40 | 41 | 48 | 32 | 27 | 29 | 15 |

From the above experimental results, it can be seen that because Examples 1 to 8 have specific first components and second components, and the contents of each component are within the range defined by the present disclosure, ideal resin compositions and cured products made therefrom can be obtained.

Furthermore, because Comparative Example 1 only uses prepolymer B2 prepared from PPG, it does not meet the condition of prepolymer A/prepolymer B being 1.0 to 3.0, such that the ideal resin composition and cured product made therefrom cannot be obtained.

In addition, since Comparative Example 2 uses an acrylate monomer with an excessively high Tg, it does not meet the condition that the glass transition temperature of the acrylate monomer is less than 25° C., so that the ideal resin composition and cured product made therefrom cannot be obtained.

Finally, because Comparative Example 3 does not contain vinyl ether monomer, and both the ratio of prepolymer A and prepolymer B and the amount of the second component are less than the ranges defined by the present disclosure respectively, it is impossible to obtain the ideal resin compositions and cured products.

In summary, through the resin composition of the present disclosure and the cured product thereof, the application of 3D printing products can be expanded.

The present invention is not limited to the embodiments described above but encompasses various modifications made within the ranges indicated in the claims. Embodiments obtained by appropriately combining the technical means disclosed in different embodiments are also included within the technical scope of the present invention.

While the present disclosure has been described by means of specific embodiments, numerous modifications and variations could be made thereto by those skilled in the art without departing from the scope and spirit of the present disclosure set forth in the claims.

What is claimed is:

1. A resin composition, comprising:
a first component comprising 75˜85 parts by weight of polyurethane polyurea methacrylate prepolymer, 15˜25 parts by weight of a diluting monomer and 0.5˜1.5 parts by weight of a photoinitiator; and
a second component comprising an aliphatic diamine, and an equivalent number ratio of active amine groups in the aliphatic diamine to isocyanate groups in the polyurethane polyurea methacrylate prepolymer (equivalent number of the active amine groups/equivalent number of the isocyanate groups) is 0.9˜1.0;
wherein the polyurethane polyurea methacrylate prepolymer comprises prepolymer A made from polytetramethylene ether glycol and prepolymer B made from polypropylene glycol, and a weight ratio of the prepolymer A to the prepolymer B (prepolymer A/prepolymer B) is 1.0˜3.0, and
the diluting monomer comprises an acrylate monomer and a vinyl ether monomer, and the acrylate monomer has a glass transition temperature of less than 25° C.

2. The resin composition of claim 1, wherein a content of the vinyl ether monomer: a content of the acrylate monomer is 1:2˜5.

3. The resin composition of claim 1, wherein the glass transition temperature of the acrylate monomer is less than 0° C.

4. The resin composition of claim 1, wherein the polyurethane polyurea methacrylate prepolymer is formed in the following manner: reacting polytetramethylene ether glycol or polypropylene glycol with diisocyanate to form polyurethane, and then capping an isocyanate functional group at an end of the polyurethane using tert-butylaminomethacrylate.

5. The resin composition of claim 4, wherein the tert-butylaminomethacrylate is tert-butylaminoethyl methacrylate, and the diisocyanate is isophorone diisocyanate or trimethylhexamethylene diisocyanate.

6. The resin composition of claim 1, wherein the photoinitiator is at least one selected from the group consisting of (2,4,6-trimethylbenzoyl)diphenylphosphine oxide, (2,4,6-trimethylbenzoyl)di-p-tolylphosphine oxide and bis(2,4,6-trimethylbenzoyl)-phenylphosphine oxide.

7. The resin composition of claim 1, wherein a viscosity of the resin composition at 25° C. is 7,000˜10,000 cP.

8. A cured product of a resin composition, which is formed by first subjecting the resin composition of any one of claim 1 to UV light curing molding, followed by heating and polycondensation in the solid phase, and the cured product of the resin composition has a resilience of more than 30%, an ultimate tensile strength of more than 15 MPa, and an elongation at break of more than 200%.

9. A cured product of a resin composition, which is formed by first subjecting the resin composition of any one of claim 2 to UV light curing molding, followed by heating and polycondensation in the solid phase, and the cured product of the resin composition has a resilience of more than 30%, an ultimate tensile strength of more than 15 MPa, and an elongation at break of more than 200%.

10. A cured product of a resin composition, which is formed by first subjecting the resin composition of any one of claim 3 to UV light curing molding, followed by heating and polycondensation in the solid phase, and the cured product of the resin composition has a resilience of more than 30%, an ultimate tensile strength of more than 15 MPa, and an elongation at break of more than 200%.

11. A cured product of a resin composition, which is formed by first subjecting the resin composition of any one of claim 4 to UV light curing molding, followed by heating and polycondensation in the solid phase, and the cured product of the resin composition has a resilience of more than 30%, an ultimate tensile strength of more than 15 MPa, and an elongation at break of more than 200%.

12. A cured product of a resin composition, which is formed by first subjecting the resin composition of any one of claim 5 to UV light curing molding, followed by heating and polycondensation in the solid phase, and the cured product of the resin composition has a resilience of more than 30%, an ultimate tensile strength of more than 15 MPa, and an elongation at break of more than 200%.

13. A cured product of a resin composition, which is formed by first subjecting the resin composition of any one of claim 6 to UV light curing molding, followed by heating and polycondensation in the solid phase, and the cured product of the resin composition has a resilience of more than 30%, an ultimate tensile strength of more than 15 MPa, and an elongation at break of more than 200%.

14. A cured product of a resin composition, which is formed by first subjecting the resin composition of any one of claim 7 to UV light curing molding, followed by heating and polycondensation in the solid phase, and the cured product of the resin composition has a resilience of more than 30%, an ultimate tensile strength of more than 15 MPa, and an elongation at break of more than 200%.
